(19) United States
(12) Patent Application Publication
(10) Pub. No.: US 2016/0065328 A1
(43) Pub. Date: Mar. 3, 2016

(54) COMMUNICATIONS IN A MULTI-USER ENVIRONMENT

(71) Applicant: MagnaCom Ltd., Petach Tikva (IL)

(72) Inventors: Daniel Stopler, Holon (IL); Ilan Reuven, Ganey Tikva (IL); Amir Eliaz, Moshav Ben Shemen (IL); Roy Oren, Magshimim (IL); Shimon Benjo, Petach Tikva (IL)

(21) Appl. No.: 14/843,217

(22) Filed: Sep. 2, 2015

Related U.S. Application Data
(60) Provisional application No. 62/044,457, filed on Sep. 2, 2014.

(51) Int. Cl. H04L 1/00; H04L 27/26

(52) U.S. Cl. CPC H04L 1/0045; H04L 27/2647

(57) ABSTRACT

An orthogonal frequency division multiple Access (OFDMA) receiver may comprise a forward error correction (FEC) decoder and nonlinearity compensation circuitry. The OFDMA receiver may be configured to receive a signal that is a result of multiple concurrent, partially synchronized transmissions from multiple transmitters using different subsets of subcarriers. The nonlinearity compensation circuit may be operable to generate estimates of constellation points transmitted on each of a plurality of the subcarriers of the received signal. The generation of the estimates may be based on soft decisions from the FEC decoder, and models of nonlinear distortion introduced by the multiple transmitters. The receiver may comprise control circuitry operable to allocate a plurality of subcarriers among the multiple transmitters, wherein, for each one of the transmitters, which one or more of the subcarriers are allocated to the one of the transmitters is determined based on an amount of distortion introduced by the transmitters.

### PRIORITY CLAIM

This application claims priority to the following application(s), each of which is hereby incorporated herein by reference:

U.S. provisional patent application 62/044,457 titled “Communications in a Multi-User Environment” filed on Sep. 2, 2014.

### INCORPORATION BY REFERENCE

Each of the following applications is also hereby incorporated herein by reference:

U.S. patent application Ser. No. 14/687,861 titled “Transmitter Signal Shaping” filed on Apr. 15, 2015; and
U.S. patent application Ser. No. 14/809,408 titled “Orthogonal Frequency Division Multiplexing Based Communications Over Nonlinear Channels” filed on Jul. 27, 2015.

### BACKGROUND

Limitations and disadvantages of conventional approaches to communications in a multi-user environment will become apparent to one of skill in the art, through comparison of such approaches with some aspects of the present method and system set forth in the remainder of this disclosure with reference to the drawings.

### BRIEF SUMMARY

Methods and systems are provided for communications in a multi-user environment, substantially as illustrated by and/or described in connection with at least one of the figures, as set forth more completely in the claims.

### BRIEF DESCRIPTION OF THE DRAWINGS

FIG. 1 is a block diagram of an example transmitter configured to implement aspects of this disclosure.

FIG. 2 is a plot for an example digital non-linear function.

FIG. 3 is a block diagram of a first example receiver configured to implement aspects of this disclosure.

FIG. 4 is a block diagram of a second example receiver configured to implement aspects of this disclosure.

FIG. 5 depicts an example network comprising a plurality of UEs communicating with a base station.

### DETAILED DESCRIPTION

Aspects of this disclosure enable implementing OFDMA in cellular while maintaining low Peak-to-Average Power Ratio (PAPR). Such may be of particular interest to OFDMA in the cellular UL (up link) direction since transmitter (e.g., of user equipment (UE) such as a smartphone, laptop, tablet, and the like) power amplifier (PA) efficiency is critical to achieving high power in small form factor and low battery consumption. This cellular uplink scenario is just one of many multi user scenarios to which aspects of this disclosure are applicable. Similarly, while some example schemes of nonlinear distortion cancellation are described here, aspects of this disclosure are compatible with other schemes of non-linear distortion cancellation.

While there are many advantages to OFDM and OFDMA (OFDM multiple accesses), a well-known issue with OFDM is high PAPR. In some cases (e.g. LTE cellular standard 3GPP TS 36.211 V11.5.0 (2013-12): “Physical Channels and Modulation”), the problem of high PAPR has resulted in using single carrier UL (SC-FDMA) in contrast to OFDMA downlink used in the same standard. While single carrier has many limitation vs. OFDMA, it reduces the PAPR requirement and thus allowing higher PA efficiency, lower power consumption, and smaller form factor. These savings are critical for mobile devices. Aspects of this disclosure teach how to use OFDMA or SC-FDMA (e.g. for LTE) while keeping low PAPR at the mobile device. In an example implementation, such aspects comprise adding a digital non-linear function at the transmit end of the communication link and a multi-user non-linear solver at the receive end of the communication link.

The non-linear distortion generated by a UE UL transmitter can be divided into three types according to its relative location in frequency and the victim UL transmissions:
(1) Distortion affecting the frequency portions (subcarriers) allocated to the interfering UE itself (i.e. the victim UE is also the interfering one).
(2) Distortion affecting frequency portions (subcarriers) allocated to other UE's that belong to the same channel (i.e. same carrier) and same base station (i.e. intra channel/carrier victims).
(3) Distortion affecting frequency allocated to other channels/carriers thus violating spectral compatibility mask (i.e. mainly adjacent carrier/channel interference).

In an example implementation, aspects of this disclosure resolve case (3) in the transmitter using a digital non-linear function introduced at the transmitters in addition to power spectral density (PSD) shaper. In an example implementation, aspects of this disclosure resolve cases (1) and (2) at the receive end.

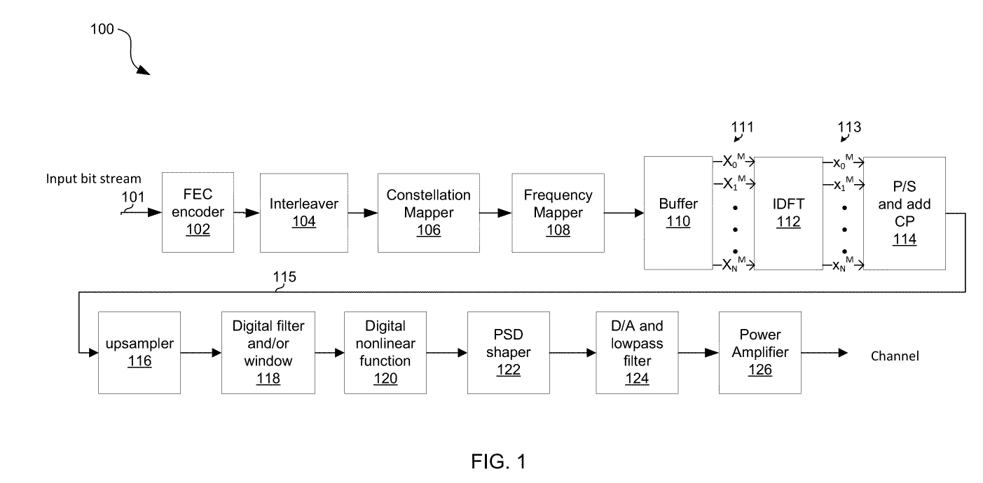

FIG. 1 is a block diagram of an example transmitter 100 configured to implement aspects of this disclosure. In this example implementation, the input bit stream 101 is encoded by FEC encoder 102, interleaved by interleaver 104, mapped to symbol constellations (e.g., QAM mapping) by constellation mapper 106, and then mapped in frequency, by frequency mapper 108, to subcarriers allocated to a specific mobile unit. These subcarriers may be allocated by the base station, and may or may not be continuous in frequency. Most of the advantage of OFDMA is achieved by using non-contiguous subcarriers or groups of subcarriers, thus enabling diversity in frequency and interference averaging. The inverse discrete Fourier transform (IDFT) 112 is used to transform time-domain signal 111 to frequency-domain signal 113, circuit 114 then adds a cyclic prefix and performs parallel to serial conversion resulting in signal 115. Signal 115 is then interpolated by circuit 116 and/or windowed by circuit 118. This resulting oversampled signal 119 is then passed through circuitry 120 implementing a digital non-linear function (DNF) and a PSD Shaper circuit 122. In another example implementation, the DNF circuit 120 and PSD shaper circuit 122 may be located before cyclic prefix insertion circuit 114.

In an example implementation, the digital non-linear function (DNF) implemented by circuit 120 is a smooth and monotonic non-linearity designed to allow operation under deep compression at the Power Amplifier 126 without violating an applicable transmission mask (e.g., set forth by a regulatory or standards body). In addition, the DNF circuit 120 may be optimized to reduce backoff of the PA 126, and to improve receiver handling of distortion generated by the DNF circuit 120. The DNF circuit 120 may also limit the signal amplitude transmitted to a range in which the PA distortion is well specified (by design of the PA 126) (i.e. the PA 126 still distorts the signal but in a controlled way (e.g. monotonic memory-less behavior)).

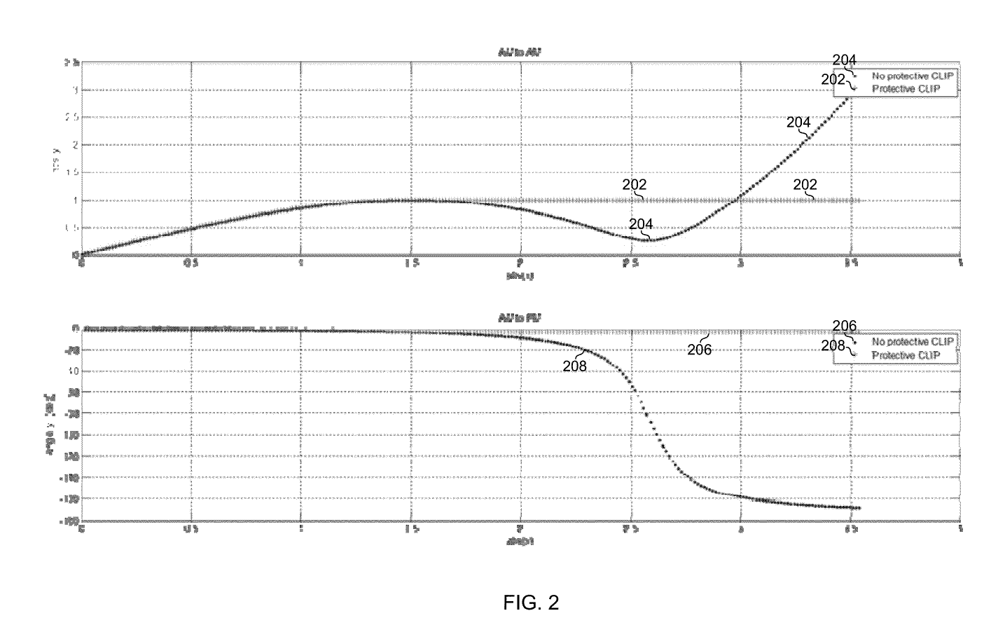

A plot for an example digital non-linear function is shown in FIG. 2. As shown by line 204, the AM to AM characteristic of the PA at deep compression may be not one-to-one. The example DNF in FIG. 2 (corresponding to line 202 and denoted as “protective clip”) may predominate the overall nonlinear characteristic of the transmitter in order to reconstruct the data with substantially known nonlinear characteristic (as the nonlinear response of the PA 126 may vary in time). Likewise, the DNF may be chosen to simplify the reconstruction of the data under known nonlinearity at the receive end.

### PSD Shaper

In an example implementation, the PSD shaper circuit 122 is located right after the circuit 120 implementing the digital non-linear function and is used to reject distortion components generated by the circuit 120. The distortion component generated by the circuit 120 at out of band frequencies may be computed and cancelled by the PSD shaper before being input to the PA 126.

### Receiver

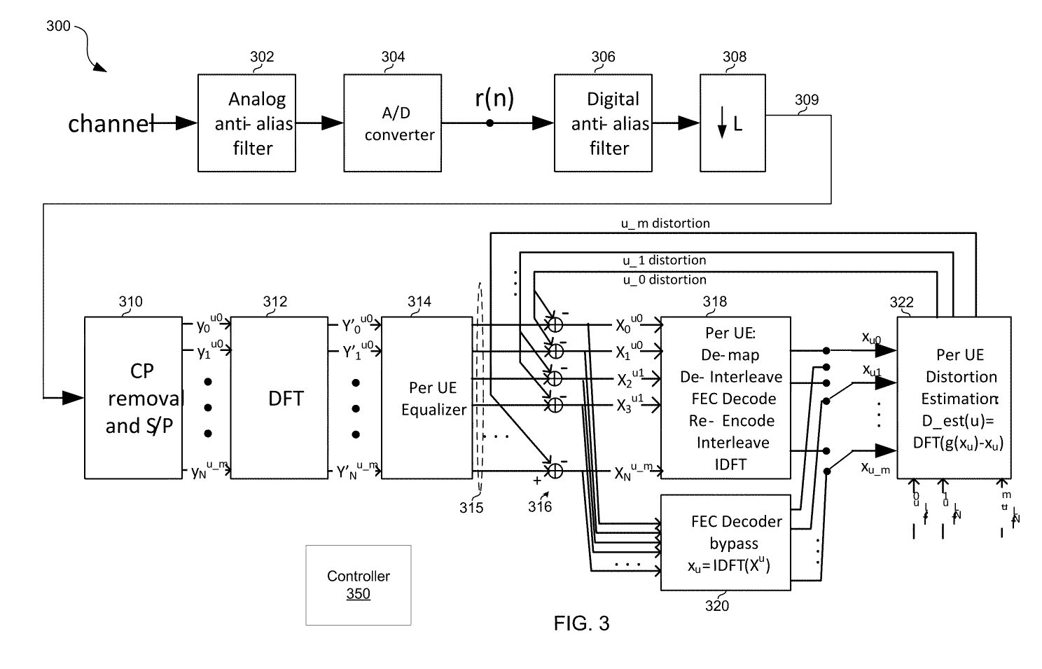

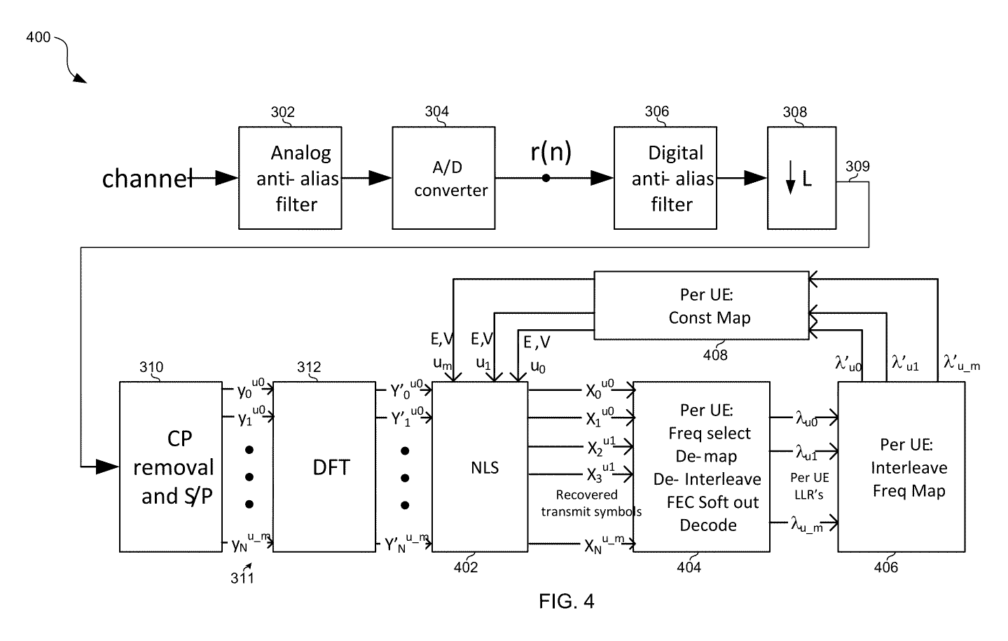

A block diagram of a first example receiver operable to processes signals transmitted by the transmitter of FIG. 1 is shown in FIG. 3. A block diagram of a second example receiver operable to processes signals transmitted by the transmitter of FIG. 1 is shown in FIG. 4. However, the invention is not limited to these particular reception algorithms but is applicable to any reception algorithm for reconstruction of data from a signal which is subject to severe nonlinear distortion. For these two example receivers, a memoryless non-linear function is assumed for each transmitter (denoted as f_{NL}_{_{—}}ᵤ(x)), and it the non-linear function is assumed known to the receiver (e.g., a receiver residing in a cellular base station). While the PSD Shaper circuit 122 may introduce memory into the transmitter non-linearity, in practice this typically has minor effects. Nevertheless, systems and methods described in this disclosure can also handle a non-linear function with memory.

### Receiver Example 1

Referring to FIG. 3, the receiver 300 (e.g., of a basestation that supports multiple concurrent transmitters) downconverts (not shown) the signal received from the channel, and then filters, via circuit 302, and digitizes, via circuit 304, the received signal to generate digitized signal r(n). The digitized signal r(n) is processed by anti-aliasing filter 306 and digitally downsampled by circuit 308 to result in signal 309. A Cyclic Prefix (CP) part is removed from signal 309 by circuit 310 and the signal is converted to a parallel representation 311. Discrete Fourier transform (DFT) circuit 312 converts the signal from the time domain to the frequency domain, after which linear equalization is applied by circuit 314. The resulting frequency domain signal 315 is corrupted by distortion—both intra-transmitter and inter-transmitter interferences may be present in the resulting frequency domain signal 315.

The receiver of FIG. 3 uses several iterations. In each iteration, the previous iteration distortion estimate is first subtracted from signal 315 in subtractor 316. Then, in circuit 318, each transmitters recovered subcarriers (i.e. frequency portion) are selected, de-mapped to log likelihood ratios (LLRs), de-interleaved, FEC decoded, FEC Re-encoded, interleaved, and then converted from a frequency domain representation to a time-domain representation via an IDFT operation. The estimated time domain signal xᵤ for the transmitter u is used to estimate the distortion inflicted by transmitter u (to itself (intra-transmitter interference) and/or to other transmitters (inter-transmitter interference)). Namely, denoting the memory-less non-linearity for transmitter u as g(x)=f_{NL}_{_{—}}ᵤ(x), and denoting its transmission as x^{u}, the estimated distortion in frequency generated by user u is DFT(g(x^{u})−x^{u}). This distortion estimate is computed, by circuit 3122, per transmitter and subtracted from the combined received signal 315 in the frequency domain. Note that the distortion estimate has typically a wider bandwidth then those subcarriers allocated for the transmitter's transmission. Therefore, subtracting the distortion estimates cleans both same transmitter's transmission and other victim transmitter's transmissions.

In the first iteration there is still no “previous distortion estimate” therefore the first iteration de-maps and decodes directly the distorted signal, suffering a higher distortion floor. However, the decoding for first (and later) iterations does not need to be exact to provide a gross distortion estimate. This gross distortion estimate is subtracted from the input of second (next) iteration, therefore improving the starting point for the second (next) iteration. The better starting point improves the decoder performance and, therefore, also improves the distortion estimation of the second iteration, thus further improving the starting point of the third (next) iteration. This process continues by which each iteration improves decoder performance and distortion estimation, until, for example, all transmitter transmissions are decoded successfully or further improvement is below a threshold, or a maximum number of iterations are complete.

### Receiver Example 2

Referring to FIG. 4, an advantage of the receiver of FIG. 4 compared to the receiver of FIG. 3 is the ability to receive highly distorted signal by use of iterations with the decoder, and also to achieve significant distortion reduction without requiring decoder assistance.

The receiver 400 down converts (not shown) the signal received via the channel, and then filters, via circuit 392, and digitizes, via circuit 304, the received signal. The digitized signal r(n) is anti-aliased, via circuit 306, and digitally down sampled, by circuit 308, resulting in signal 309. it's a Cyclic Prefix (CP) part of signal 309 is then removed by circuit 310 and the signal is converted to a parallel representation 311. Discrete Fourier Transform (DFT) circuit 312 converts the signal from a time-domain representation to a frequency-domain representation. Samples of the frequency domain representation are denoted as (Y₀^{u0}, Y₁^{u0}, . . . , Y_{N-1}^{u}^{ₘ}, Y_{N}^{u}^{ₘ})T where 1 . . . N is the subcarrier index, and u₀, u₁, . . . uₘ is the index of the transmitters transmitting on those subcarriers. Then, the non-linear solver circuit (NLS) 402 estimates the aggregated transmission symbol —including all users—denoted X=(x₀^{u0}, x₁^{u0}, . . . , x_{N-1}^{u}^{ₘ}, x_{N-1}^{u}^{ₘ})^{T}. At this first iteration, if the receiver 400 lacks prior information, the expectation for each user u and subcarrier k, (denoted E_{u,k}) is set to 0, and the variance for each user u and subcarrier k (denoted V_{u,k}) is set according to respective constellation power. The NLS circuit 402 significantly reduces distortion, but some noise enhancement may result from first NLS iteration (since it is not aided by decoder information). In circuit 404, the output of the NLS circuit 402 is divided up into the respective user's symbols, and per transmitter, the symbols are demapped, de-interleaved, and FEC soft decoded, to produce λᵤ LLR's and decoded bits. This completes the first outer iteration.

Subsequently one or more additional outer iterations may be performed. In each additional outer iteration, the NLS 402 combines soft information (e.g., LLRs) derived from the decoder 404, with channel information vector from the DFT 312 (denoted (Y₀^{u0}, Y₁^{u0}, . . . , Y_{N-1}^{u}^{ₘ}, Y_{N}^{u}^{ₘ})^{T}). More specifically each outer iteration does the following: The LLRs output by the decoder 404 are input to circuit 406 where they are re-interleaved per transmitter (as in transmit interleaving), and frequency mapped into the subcarriers used per transmitter (the same as was done by the transmitter). The LLRs mapped to each subcarrier are constellation mapped producing new expectancy E_{u,k} and variance V_{u,k} corresponding to estimated subcarrier value and its uncertainty. The NLS circuit 402 uses this new set of expectations E_{u,k} and variance V_{u,k} values together with the channel information vector (Y₀^{u0}, Y₁^{u0}, . . . , Y_{N-1}^{u}^{ₘ}, Y_{N}^{u}^{ₘ})^{T}) from the DFT 312, to re-estimate the aggregate transmission signal (x₀^{u0}, x₁^{u0}, . . . , x_{N-1}^{u}^{ₘ}, x_{N}^{u}^{ₘ})^{T}.

For a transmitted signal from a transmitter such as the one of FIG. 1, the received signal in the frequency domain (excluding noise) at the receiver (e.g., of a base station) can be represented as:

$$Y = {\sum }_{u = 0}^{{N}_{u}} {H}_{u} . * DFT ( {f}_{NL\_u} ( IDFT ( {P}_{u} . * X ) ) )$$

where
X=(x₀^{u0}, x₁^{u0}, . . . x_{N-1}^{u}^{ₘ}, x_{N}^{u}^{ₘ})^{T} is a vector of size N_{BINS}×1 that aggregates the transmission signal for all users, according to their frequency mapping.
Pᵤ is a vector of size N_{FFT}×1 that applies the transmission filter of user u over its own subcarriers and zeros the subcarriers of all other users ≠u.
Hᵤ is a vector of size N_{FFT}×1 vector corresponding to the OFDM channel over which signals are received from user u
f_{NL}_{_{—}}ᵤ(x) is a scalar function representing memoryless non-linearity of user u.
Although aspects of this disclosure are described using a memoryless non-linearity, aspects of this disclosure are also applicable to handling non-linearity with memory.

The different transmitters are typically orthogonal in frequency (using different subcarriers), this allows defining an aggregate transmit symbol containing all the users X=(x₀^{u0}, x₁^{u0}, . . . , x_{N-1}^{u}^{ₘ}, x_{N}^{u}^{ₘ})^{T}. The vector Pᵤ is used to select only user u subcarriers from the set of all subcarriers and apply its transmission filter to them. Even though the different transmitters use different subcarriers the distortion does spill over from a user to its adjacent neighbors, therefore the IDFT, DFT and Hᵤ are N_{FFT} wide, thus allowing to model complete overlap between the users. Alternately smaller DFT and Hᵤ size may be used as long as there is sufficient (based on implementation-specific performance criteria, for example) overlap to account for distortion spilling over from one user to its adjacent users.

In order to uncover the distorted signal, the receiver 400 minimizes the following residual signal denoted r(x). Note that while different transmitters (users) are typically orthogonal in frequency, their distortion does spill over. Accordingly, the signal processing performed in the receiver may process the signals to uncover all user signals together. This may be expressed as:

$$r ( x ) = Y - {\sum }_{u = 0}^{{N}_{u}} {H}_{u} . * DFT ( {f}_{NL\_u} ( IDFT ( {P}_{u} . * X ) ) )$$

If the received noise floor is not white, the above expression may be rescaled (divided) per subcarrier according to noise standard deviation per subcarrier.

The NLS circuit may perform the following minimization (and repeat it iteratively each outer iteration).

$${arg min}_{{x}_{1} , {x}_{2} , … {x}_{{N}_{u}}} {‖ Y - {\sum }_{u = 0}^{{N}_{u}} {H}_{u} . * DFT ( {f}_{NL\_u} ( IDFT ( {P}_{u} . * X ) ) ) ‖}^{2} + {\sum }_{u = 0}^{{N}_{u}} {\sum }_{k = 0}^{{N}_{BINS}^{u}} \frac{{\vert Δ {x}_{u , k} \vert}^{2}}{{V}_{u . k}}$$

where:
N_{BINS}^{u} is the number of subcarriers allocated for user u.
X=(x_{u,1}, x_{u,2}, . . . , x_{u,N}_{_{BINS}}_{^{u}}) is a vector of size N_{BINS}×1 vector that aggregates the transmission signal for all users, according to their frequency mapping.
∥·∥² denotes the square of Frobenius norm of a vector
Y is the received signal in frequency
Pᵤ is a vector of size N_{FFT}×1 that applies the transmission filter of user u over its own subcarriers and zeros the subcarriers of all other user ≠u.
Hᵤ is a vector of size N_{FFT}×1 corresponding to the OFDM channel over which signals are received from user u
Nᵤ is the number of users
f_{NL}_{_{—}}ᵤ(x) is a scalar function representing memory less non-linearity of user u.
Δx_{u,k}=x_{u,k}−E_{u,k} is the deviation between current subcarrier estimate (for user u at subcarrier k) and some expected subcarrier value denoted E_{u,k}
V_{u,k} is the variance in the sense of uncertainty of previous expectancy E_{u,k} (for user u at subcarrier k)

This minimization estimates the aggregated transmission signal=(x₀^{u0}, x₁^{u0}, . . . , X_{N-1}^{u}^{ₘ}, x_{N}^{u}^{ₘ})^{T}, using, as reference, the values of E_{u,k} and V_{u,k} for a (for all, or a subset, of users u, and all, or a subset, of subcarriers k) estimated by the decoder during the previous outer iteration. Initially when no reference exists, zero reference may be used, i.e. E_{u,k}=0 and the variance V_{u,k} may be set according to respective constellation power.

One approach to performing the minimization is based on gradient descent using (x), the following equation specifies the complex formulation of the gradient.

$$\frac{\partial \{ {\sum }_{i = 1}^{N} {\vert {r}_{i} ( \overline{X} ) \vert}^{2} \}}{\partial Re {X}_{k}} + j \frac{\partial \{ {\sum }_{i = 1}^{N} {\vert {r}_{i} ( \overline{X} ) \vert}^{2} \}}{\partial Im {X}_{k}} = - 2 {\sum }_{v = 0}^{Nv - 1} {P}_{u , k}^{*} ( {DFT}_{Σ n} ( \frac{\partial {f}_{{NL}_{u}}}{\partial X} {( {IDFT}_{Σ k} ( {P}_{u} \cdot x ) )}^{*} \cdot {{IDFT}_{Σ i} ( {Q}_{u , i}^{*} \cdot {r}_{i} ( \overline{x} ) )}_{n} ) + {DFT}_{Σ n} ( \frac{\partial {f}_{{NL}_{u}}}{\partial {X}^{*}} ( {IDFT}_{Σ k} ( {P}_{u} x ) ) \cdot {{IDFT}_{Σ i} ( {Q}_{u , i}^{*} \cdot {r}_{i} ( \overline{x} ) )}_{n}^{*} ) )$$

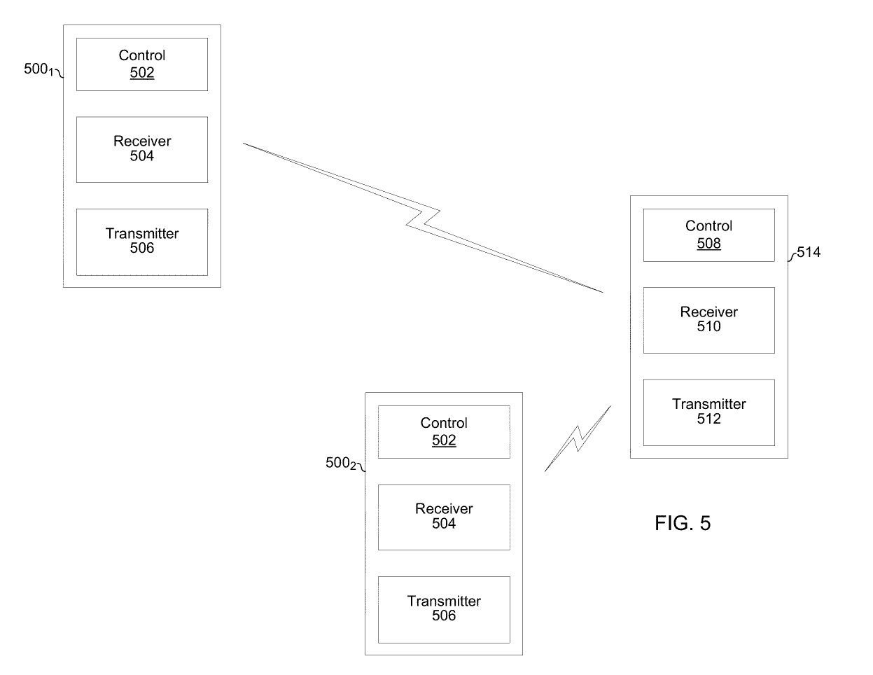

FIG. 5 depicts an example network comprising a plurality of UEs communicating with a base station. The network comprises two UEs 500₁ and 500₂ and a base station 514. Each UE 500 comprises control circuitry 502, a receiver 504 (e.g., an instance of receiver 300 of FIG. 3 or 400 of FIG. 4), and a transmitter 506 (e.g., an instance of transmitter 100 of FIG. 1). The control circuitry 502 may comprise, for example, a processor and memory operable to control and configure operation of the receiver 504 and receiver and also perform higher layer functions (e.g., MAC layer functions, network layer functions, transport layer functions, and application layer functions).

The base station 514 comprises control circuitry 508, a receiver 510 (e.g., an instance of receiver 300 of FIG. 3 or 400 of FIG. 4), and a transmitter 512 (e.g., an instance of transmitter 100 of FIG. 1). The control circuitry 508 may comprise, for example, a processor and memory operable to control and configure operation of the receiver 504 and receiver 506, and also perform higher layer functions (e.g., MAC functions, network layer functions, transport layer functions, and application layer functions). Such higher layer functions may comprise, for example, allocating resources (e.g., timeslots on which to transmit, subcarriers on which to transmit, etc.) among a plurality of transmitters which communicate with the base station 514. Such higher layer functions may comprise, for example, instructing each of the transmitters 500 as to a power level or power backoff with which they are to transmit.

### Multi User Reception Issues

The cellular multi-user scenario introduces several difficulties not encountered in the single user case.
(1) Near transmitters (those close to the base station, such as 500₂ in FIG. 5) are being received at much higher power targets and rates than far transmitters (such as 500₁ in FIG. 5). This is due to transmit power limit and/or transmit power control limiting outgoing interference.
(2) Power control error varies between transmitters resulting in different transmitters (e.g., 506 of 500₁ and 506 of 500₂) having different noise margins.
(3) Variation of interference in frequency, making some transmissions more susceptible to decoding errors than other.
(4) Wireless standards use retransmission schemes either ARQ (Automatic repeat request) or Hybrid ARQ. This, on one hand, results in preference of relatively high packet error rate MAC policy, (e.g. even 1-5% in LTE thanks to efficiency of HARQ). On the other hand, this results in some packets consisting of only incremental redundancy and therefore not being self-decodable.
(5) Some legacy transmitters may be operating in single carrier mode (SC-FDMA) rather than OFDMA, and the base station receiver therefore needs to be able to handle at the same symbol time both OFDMA and SC-FDMA.

Items (1), (2) and (3) mean that distortion of transmitters arriving at high power may cover/dominate the reception of those adjacent (in frequency) transmitters arriving at lower power (but not necessarily at lower rates). To account for this, a successive cancellation approach may be used in which the distortion cancellation scheme initially applies decoding only for those users having sufficient SNRs, while bypassing circuit 318 or 404 for users having too low SNR. Applying decoding for users having too low SNRs would corrupt the signal relative to the not decoded version. Thus, for both the receiver of FIG. 3 and the receiver of FIG. 4, a distortion estimation that does not rely on decoding may be used (i.e. for the receiver of FIG. 3, the distortion estimation in frequency that generated for low SNR user u may be DFT(g(IDFT(X^{u}))−IDFT(X^{u}))). For low-SNR users, it is also possible to base the distortion estimation on slicing (i.e. DFT(g(IDFT(slice(X^{u})))−IDFT(slice(X^{u})))), where slice(x) quantizes x to the nearest transmit constellation point. In contrast, the receiver of FIG. 4 may still use the NLS 402 that is not aided by the decoder (this corresponds to the first outer iteration—which does not use expectancy E_{u,k,} variance V_{u,k}—as described above). After several iterations, the higher SNR users are decoded correctly enabling to cancel most of their distortion. This in turn improves SNR of weaker transmitters and allows decoding them as well.

A similar approach may be used to handle item (5) where legacy Single Carrier FDMA transmitter transmissions coexists over the same time symbols (but on different subcarriers) as OFDMA transmissions. For Single Carrier FDMA, the NLS 402 may be less effective. However, the receiver 400 may be configured based on an assumption that the legacy transmitter was operated at sufficient power backoff and therefore is not distorted. Thus, distortion from compressed OFDMA transmission may spill over onto the legacy Single Carrier FDMA transmission but not vice versa. The receiver may handle this by first recovering the OFDMA transmissions, and then subtracting the distortion they generate from the legacy single carrier FDMA transmissions.

Another approach which a receiver in accordance with an example implementation of this disclosure may use for addressing items (1), (2), (3) is to manage the UL power and UL interference floor variation by having a per transmitter power backoff policy that varies according to transmitter reception power at the receiver. For example, the network coordinator (e.g., base station 514 in FIG. 5) may allocate near transmitters (close to the receiver and therefore having low path loss, such as transmitter 506 of UE 500₂ in FIG. 5) to frequency portions that are highly interfered with by other cells, since near transmitters have significant power headroom and therefore may manage this high level of interference by increasing their transmission power. Similarly, far transmitters (having high path loss, such as transmitter 506 of UE 500₁ in FIG. 5) may be allocated to frequency portions that experience low interference by other cells, since far transmitters operate near their maximum transmission power and don't have additional power headroom. This arrangement eases multi-user distortion handling. In one example implementation, the network coordinator (e.g., base station 514) may instruct the far transmitters (e.g., 506 of UE 500₁), which typically having little power headroom, to use low backoff, and instruct the near transmitters (e.g., 506 of UE 500₂), transmissions from which are typically received at high power, to use higher backoff. This results in the far transmitters operating in PA efficient, but compressed (non-linear distorted) region of their response curves, while the receive end device (e.g., base station 514) may instructed the near transmitters to apply higher backoff resulting in them spilling less distortion onto signals from weaker transmitters. In another example implementation, the base station may keep some, or relatively more, guard band between high power transmitters and low power transmitters by keeping high backoff or un-allocated frequency portions (but may have less, or no, guard band between different frequency portions allocated to different high power/low backoff transmitters, and less, or no, guard band between different frequency portions allocated to different low power/low backoff transmitters.

To address the problem of item (4) a receiver in accordance with an example implementation of this disclosure may use one or more of the following two approaches.
(A) As described above, for cases where transmitter SNR is too low for decoding (so the receiver will eventually need HARQ or ARQ) the receiver 300 (e.g., a cellular base station) may use the decoder bypass path 320, and the receiver 400 may use NLS 402 unaided by decoder 404) This allows to reduce the distortion to some extent without the need to successfully decode.
(B) While approach (A) is useful for transmitter signals arriving at low power, transmitter signals arriving at high power may corrupt signal for other adjacent transmitters. Therefore, the receiver may use the same per-transmitter backoff policy described above, where transmitters whose signal arrives at high power (especially over high interference channel) may use higher backoff and therefore introduce manageable distortion into signals of frequency adjacent transmitters, while transmitters arriving at low power may use low backoff and therefore get higher power efficiency.

These two approaches, may still leave some distortion un-handled. Each transmission may be spread across a wide range of frequencies (i.e., mix/intersperse subcarriers allocated to different transmitters). Since the HARQ probability is low (<5%), and since the system may use a per transmitter backoff policy that avoids significant distortion from high reception power transmission, distortion averaging may result from such mixing transmitters in frequency. Such interspersing of subcarriers allocated to high power/low backoff (e.g., operating above a determined compression point) transmitters and subcarriers allocated to low power/high backoff (e.g., operating below a determined compression point) may enable successful distortion cancellation even when some retransmissions are needed since the unhandled distortion power (due to failed blocks) is typically small relative to the typical noise+interference (i.e. thermal noise+external interference floor that the receiver always manages), and is spread equally among all victim users. On the contrary, if almost all reception power were concentrated in one transmissions from one transmitter (and transmissions from other transmitters are much weaker), and a transmission from that strong user were to fail decoding (i.e. need a retransmission) then, despite the low HARQ probability, the system may have a “single point of failure” (i.e. the strong user), and be more likely to suffer from poor performance. Thus, the backoff policy used in the system may avoid single points of failure by increasing backoff for those users that are very strong. This does not incur a big performance penalty, since it is more important to optimize efficiency of users whose signals are received with low signal strength than it is to optimize efficiency of users whose signals are received with high signal strength.

Another issue in item (4) is handling of incremental redundancy. That is, in the case that an initial UL transmission was not received correctly, and the receiver asked the transmitter u to retransmit only additional redundancy (rather than retransmitting the entire transmission), this redundancy-only packet is not self-decodable (i.e., not decodable based only on the information contained in the packet). Thus, the receiver needs to keep the previous distorted initial transmission, Dᵤ in order to decode it in conjunction with the new redundancy-only packet Rᵤ. Similarly it is possible that even if the retransmission Rᵤ is self-decodable, its SNR is too low to decode it without using the initial transmission Dᵤ. In both cases, the multi-user distortion cancellation scheme implemented in the receiver, when demodulating an OFDMA signal that includes a combination of some new transmissions Dᵤ₁ Dᵤ₂ Dᵤ₃ Dᵤₖ for users u₁, u₂, . . . uₖ, and some retransmissions Rᵥ₁ Rᵥ₂ Rᵥ₃ Rᵥ₄ for users v₁, v₂, . . . vₖ, may use both initial distorted copies of the initial transmissions Dᵤ₁ Dᵤ₂ Dᵤ₃ Dᵤ₄ of the users v₁, v₂, . . . vₖ, on top of the newly-received OFDM signal comprising the retransmission, and decode all this information together i.e. may decode all of Dᵤ₁ Dᵤ₂ Dᵤ₃ Dᵤₖ, Dᵥ₁ Dᵥ₂ Dᵥ₃ Dᵥ₄ and Rᵥ₁ Rᵥ₂ Rᵥ₃ Rᵥ₄ during the same one or more iterations).

In an example implementation, some or all of a plurality of OFDMA transmitters (e.g., transmitters of UEs 500₁ and 500₂ in FIG. 5) are allocated substantially to equally-spaced subcarriers. That is, allocated a subcarrier subset where the indices of the subcarriers in the subset are k₀+K·l, where all k₀, K, and l are integers, and K is the equal-spacing between the indices, and l either denotes the set S={0, 1, 2, . . . , L−1} or a subset of this set. For this allocation, non-linear distortion induced by each transmitter falls on the same index subset k₀+K·l, or its extension, namely k₀+K·n, where n is an integer not included in set S. This is due to the fact that the nonlinear distortion incarnates as higher order intermodulation between the transmitter's subcarriers and, since the transmitter's subcarriers are equally spaced, any integer combination of two or more indices (from the equally-spaced subset k₀+K·l) is associated with an intermodulation at a subcarrier of this subset or its extension: k₀+K·n.

In order to relax the restrictions posed on the allocation of subcarriers to the different transmitters, the network coordinator (e.g., basestation 214 in FIG. 5) may group, to a subset of subcarriers having equally-spaced indexes, several users which operate at comparable compression conditions (substantially the same power or power backoff) and thus generate roughly the same nonlinear distortion level. In this allocation, nonlinear distortion of the users affects only the users in the same group. In particular, only users with relatively highly compressed transmission signal are allocated to such a subset of equally-spaced subcarriers, and users with relatively linear (or mildly compressed transmission) are allocated to the rest of the subcarriers. For example, users which operate at high backoff and thus do not necessitate a receiver to perform complex reception techniques (such as the operations described above as performed by receivers 300 and 400) to resolve their own nonlinearity may be allocated to a different subset of equally-spaced subcarriers. In this manner, when relatively low-power/high-backoff users are allocated to a subset of equally-spaced subcarriers which is not used by relatively high-power/low-backoff users, the OFDMA receiver will not have to perform complex nonlinearity handling operations (such as the operations described above as performed by receivers 300 and 400) for recovering data from the relatively linear users (but may use such operations for signals concurrently received from the high-power/low-backoff users). This is in contrast to random allocation of subcarriers to the users, or allocation of subsets of contiguous subcarriers to the individual users, which would result in the high-power/low-backoff users corrupting the low-power/high-backoff users subcarriers, and thus require the OFDMA receiver to use complex nonlinearity handling operations for all users.

In accordance with an example implementation of this disclosure, an orthogonal frequency division multiple Access (OFDMA) receiver (e.g., 510) comprises one or more forward error correction (FEC) decoders (e.g., 318 or 404) and a nonlinearity compensation circuitry (e.g., 318, 322, 402, 404, 406, and/or 408). The OFDMA receiver may be configured to receive a signal that is a result of multiple concurrent, partially synchronized transmissions from multiple transmitters (e.g., 500₁ and 500₂) using different subsets of subcarriers. The nonlinearity compensation circuit may be operable to generate estimates of constellation points transmitted on each of a plurality of the subcarriers of the received signal. The generation of the estimates may be based on soft decisions from the FEC decoder(s), and models of nonlinear distortion introduced by the multiple transmitters. The generation of the estimates may be based on a measure of distance that is either: between a function of the received signal and a synthesized version of the received signal, or between the estimates and decoder soft values. Each of the models of nonlinear distortion introduced by the transmitters may account for a digital nonlinear function implemented in a respective one of the transmitters. The digital nonlinear function may be a protective clip. The digital nonlinear function may be the same each of the transmitters. The system may comprise control circuitry (e.g., 508) operable to allocate the subsets of the subcarriers among the multiple transmitters based on an amount of distortion induced by each of the multiple transmitters. The control circuitry may be operable to determine a subset of the multiple transmitters where each transmitter in the subset introduces less than a determined threshold amount of distortion. The control circuitry may be operable to allocate the subsets of subcarriers such that a contiguous two or more of the subsets of subcarriers are allocated to the subset of the multiple transmitters. The control circuitry may be operable to determine a subset of the multiple transmitters whose transmissions experience more than a determined threshold amount of compression, determine that one or more of the subcarriers experience more than a determined threshold amount of interference; and allocate the one or more of the subcarriers to the subset of the multiple transmitters. The control circuitry may be operable to determine which of the subsets of the subcarriers to allocate to a particular one of the multiple transmitters based on a modulation and coding scheme (which type of constellation, order or constellation, type of FEC, FEC codeword size, etc.) in use by the particular one of the transmitters. The generation of the estimates may be based on a reliability metric (e.g., SNR, EVM, Bit error rate, etc.) measured for each of said transmitters and/or for each of said subcarriers. The OFDMA receiver may be operable to process the multiple transmissions to detect data carried therein in an order determined based on quality with which the multiple transmissions are received (e.g., transmissions with higher SNR processed before transmissions with lower SNR). The OFDMA receiver may be operable to use data detected from a previously processed one of the multiple transmissions for recovering data from a later processed one of the transmissions. The OFDMA receiver may be operable, for each one of the transmissions, to determine a measure of quality (e.g., SNR, bit error rate, EVM, and/or the like) of the one of the transmissions, and determine whether to use the nonlinearity compensation circuit for processing the one of the transmissions based on the determined measure of quality. The OFDMA receiver may be operable, for each one of the transmissions, to determine a measure of quality of the one of the transmissions, process the one of the transmissions using the FEC decoder but not the nonlinearity compensation circuit if the measure of quality is above a determined threshold, and process the one of the transmissions using the FEC decoder and the nonlinearity compensation circuit if the measure of quality is below the determined threshold. At least one of the subsets of subcarriers may be a subset of equally spaced subcarriers. The control circuitry may be operable, for each one of said subcarriers, to determine to which of the transmitters to allocate the one of the subcarriers based on an amount of distortion induced by each of the multiple transmitters and an amount of noise plus interference on the one of the subcarriers (e.g., based on a difference between the amount of distortion and the amount of noise plus interference).

In accordance with an example implementation of this disclosure, a system comprises an orthogonal frequency division multiple Access (OFDMA) receiver (e.g., 510) is configured to receive transmissions from a plurality of transmitters (e.g., 506 of 500₁ and 506 of 500₂), and comprises control circuitry (e.g., 508) operable to allocate a plurality of subcarriers among the multiple transmitters, wherein, for each one of the transmitters, which one or more of the subcarriers are allocated to the one of the transmitters is determined based on an amount of distortion introduced by the transmitters (e.g., whether the one of the transmitters operates above or below a determined compression point). A first one or more of the transmitters may operate above a determined compression point, a second one or more of the transmitters may operate below a determined compression point, a first one or more of the subcarriers may be allocated to the first one or more of the transmitters, and a second one or more of the subcarriers may be allocated to the second one or more of the transmitters. Guard bands among the first one or more subcarriers and among the second one or more subcarriers may be smaller than a guard band between the first one or more subcarriers and the second one or more subcarriers. One or more of the transmitters which operate above the determined compression point may be allocated ones of the subcarriers that are interspersed with ones of the subcarriers allocated to one or more of the transmitters which operate below the determined compression point. The control circuitry may operable to group the multiple transmitters into two or more groups based on an indication of nonlinear distortion (e.g., EVM, operating point, and/or the like) introduced by each of the multiple transmitters, and allocate one of the subsets having equally spaced subcarriers to a first of the groups. The OFDMA receiver may be operable to receive a first signal comprising a first transmission, receive a second signal comprising a second transmission and a retransmission of the first transmission, and concurrently process the first transmission, the second transmission, and the retransmission of the first transmission.

The present methods and systems may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

1. A system comprising:
an orthogonal frequency division multiple Access (OFDMA) receiver comprising one or more forward error correction (FEC) decoder(s) and nonlinearity compensation circuitry, wherein:
said OFDMA receiver is configured to receive a signal that is a result of multiple concurrent, partially synchronized transmissions from multiple transmitters using different subsets of subcarriers;
said nonlinearity compensation circuitry is operable to generate estimates of constellation points transmitted on each of a plurality of said subcarriers of said received signal; and
said generation of said estimates is based on:
soft decisions from said one or more FEC decoders; and
models of nonlinear distortion introduced by the multiple transmitters.

2. The system of claim 1, wherein said generation of said estimates is based on a measure of distance that is either: between a function of said received signal and a synthesized version of said received signal, or between said estimates and decoder soft values.

3. The system of claim 1, wherein each of said models of nonlinear distortion introduced by said transmitters accounts for a digital nonlinear function implemented in a respective one of said transmitters.

4. The system of claim 3, wherein said digital nonlinear function is a protective clip.

5. The system of claim 3, wherein said digital nonlinear function is the same each of said transmitters.

6. The system of claim 1, comprising control circuitry operable to allocate said subsets of said subcarriers among said multiple transmitters based on an amount of distortion induced by each of said multiple transmitters.

7. The system of claim 1, wherein said control circuitry is operable to:
determine a subset of said multiple transmitters where each transmitter in said subset introduces less than a determined threshold amount of distortion; and
allocate said subsets of subcarriers such that a contiguous two or more of said subsets of subcarriers are allocated to said subset of said multiple transmitters.

8. The system of claim 1, wherein said control circuitry is operable to:
determine a subset of said multiple transmitters whose transmissions experience more than a determined threshold amount of compression;
determine that one or more of said subcarriers experience more than a determined threshold amount of interference; and
allocate said one or more of said subcarriers to said subset of said multiple transmitters.

9. The system of claim 1, comprising control circuitry operable to:
determine which of said subsets of said subcarriers to allocate to a particular one of said multiple transmitters based on a modulation and coding scheme in use by the particular one of the transmitters.

10. The system of claim 1, wherein said generation of said estimatesis based on a reliability metric measured for each of said transmitters and/or for each of said subcarriers.

11. The system of claim 1, wherein said OFDMA receiver is operable to process said multiple transmissions to detect data carried therein in an order determined based on quality with which said multiple transmissions are received.

12. The system of claim 11, wherein said OFDMA receiver is operable to use data detected from a previously processed one of said multiple transmissions for recovering data from a later processed one of said transmissions.

13. The system of claim 1, wherein said OFDMA receiver is operable, for each one of said transmissions, to:
determine a measure of quality of said one of said transmissions; and
determine whether to use said nonlinearity compensation circuit for processing said one of said transmissions based on said determined measure of quality.

14. The system of claim 1, wherein said OFDMA receiver is operable, for each one of said transmissions, to:
determine a measure of quality of said one of said transmissions; and
if said measure of quality is above a determined threshold, process said one of said transmissions using said one or more FEC decoders but not said nonlinearity compensation circuit;
if said measure of quality is below said determined threshold, process said one of said transmissions using said one or more FEC decoders and said nonlinearity compensation circuit.

15. The system of claim 1 wherein at least one of the subsets of subcarriers is a subset of equally spaced subcarriers.

16. The system of claim 1, comprising control circuitry operable, for each one of said subcarriers, to:
determine to which of said transmitters to allocate said one of said subcarriers based on an amount of distortion induced by each of said multiple transmitters and an amount of noise plus interference on said one of said subcarriers.

17. A system comprising:
an orthogonal frequency division multiple Access (OFDMA) receiver configured to receive transmissions from a plurality of transmitters; and
control circuitry operable to allocate a plurality of subcarriers among said multiple transmitters, wherein, for each one of said transmitters, which one or more of said subcarriers are allocated to said one of said transmitters is determined based on whether said one of said transmitters operates above or below a determined compression point.

18. The system of claim 17, wherein
a first one or more of said transmitters operate above a determined compression point;
a second one or more of said transmitters operate below a determined compression point;
a first one or more of said subcarriers are allocated to said first one or more of said transmitters; and
a second one or more of said subcarriers are allocated to said second one or more of said transmitters; and
guard bands among said first one or more subcarriers and among said second one or more subcarriers are smaller than a guard band between said first one or more subcarriers and said second one or more subcarriers.

19. The system of claim 17, wherein one or more of said transmitters which operate above said determined compression point are allocated ones of said subcarriers that are interspersed with ones of said subcarriers allocated to one or more of said transmitters which operate below said determined compression point.

20. The system of claim 17, wherein said control circuitry is operable to:
group said multiple transmitters into two or more groups based on an indication of nonlinear distortion introduced by each of said multiple transmitters; and
allocate one of said subsets having equally spaced subcarriers to a first of said groups, wherein each transmitter in said first one of said groups is allocated a different one or more subcarriers of said one of said subsets.

21. The system of claim 17, wherein said OFDMA receiver is operable to:
receive a first signal comprising a first transmission;
receive a second signal comprising a second transmission and a retransmission of said first transmission; and
concurrently process said first transmission, said second transmission, and said retransmission of said first transmission.
